(19) United States
(12) Patent Application Publication
(10) Pub. No.: US 2019/0101637 A1
(43) Pub. Date: Apr. 4, 2019

(54) WIRELESS COMMUNICATION APPARATUS AND WIRELESS COMMUNICATION METHOD

(71) Applicant: Mitsubishi Electric Corporation, Tokyo (JP)

(72) Inventor: Toshio KAWAGISHI, Tokyo (JP)

(73) Assignee: Mitsubishi Electric Corporation, Tokyo (JP)

(21) Appl. No.: 16/091,863

(22) PCT Filed: Jun. 24, 2016
(86) PCT No.: PCT/JP2016/068767

§ 371 Date: Oct. 5, 2018

(51) Int. Cl. G01S 13/76; H04W 4/48; H04W 4/80

(52) U.S. Cl. CPC G01S 13/76; H04W 4/80; H04W 4/48

(57) ABSTRACT

To provide a technique to simplify a configuration of a wireless communication apparatus that determines a position of a communication terminal. The wireless communication apparatus includes a wireless communication unit and a controller. The wireless communication unit is mounted on a vehicle. The controller switches, in stages, a strength level of a sending signal transferred by the wireless communication unit by radio. In addition to this, the controller determines, based on the strength level and the presence or absence of an answering signal transferred from a communication terminal that has received the sending signal to the wireless communication unit by radio, the position of the communication terminal.

### TECHNICAL FIELD

The present invention relates to a wireless communication apparatus and a wireless communication method.

### BACKGROUND ART

In recent years, many navigation devices have, not only the function of route guidance, but also the wireless communication function such as Bluetooth (registered trademark). And, various services are realized by connecting and interlocking the navigation device and the portable terminal of a user, through the wireless communication.

In the related art, in the connection process in which the navigation device and the portable terminal are connected through the wireless communication, the user switches to the screen for connection setting while viewing the display screen of the navigation device, and performs the operation to select and determine the portable terminal the user wishes to connect. However, the method requires many operations to do and troublesome, and also, performing the connection process while driving by the driver in person is difficult. It should be noted that such a problem can be solved if a stand-by state which enables a swift connection process, is maintained. However, in such a state, the navigation device is required to continually transfer the wireless signal for searching the portable terminal, therefore, a problem is raised that the great power is consumed by the battery.

To address such a problem, in the technique disclosed in Patent Document 1, for example, a weak wireless signal is transferred from the navigation device, and Received Signal Strength Indicator (RSSI) in which the wireless signal is received by the portable terminal is determined whether exceeding the predetermined reference value. And, when the portable terminal is determined to exist in the vehicle based on the determination result, the strength of the wireless signal used in the communication with the portable terminal is switched from weak to strong. According to the technique, consumption power by the battery of the navigation device can be suppressed.

### PRIOR ART DOCUMENTS Patent Documents

[Patent Document 1] Japanese Patent Application Laid-Open No.2015-214316

### SUMMARY

### Problem to be Solved by the Invention

However, the received signal strength in a vehicle generally fluctuates by reflection of radio wave and boarding on the vehicle. Therefore, various circuits for stabilizing the received signal strength are required, and consequently, a problem is raised that the configuration of the wireless communication apparatus becomes complicated.

Accordingly, the present invention has been made in view of the above problem, and to provide the technique to simplify the configuration of the wireless communication apparatus that determines the position of the communication terminal.

### Means to Solve the Problem

According to the present invention, a wireless communication apparatus includes a wireless communication unit mounted on a vehicle, and a controller configured to switch, in stages, a strength level of a sending signal transferred by the wireless communication unit by radio, and, based on the strength level and presence or absence of an answering signal transferred from a communication terminal that has received the sending signal to the wireless communication unit by radio, determine a position of the communication terminal.

### Effects of the Invention

Based on the strength level and the presence or absence of an answering signal transferred from a communication terminal that has received the sending signal to the wireless communication unit by radio, a position of the communication terminal is determined. Consequently, the configuration of the wireless communication apparatus that determines the position of the communication terminal is simplified.

The explicit purpose, feature, phase, and advantage of the one embodiment of the present invention will be described in detail hereunder with attached drawings

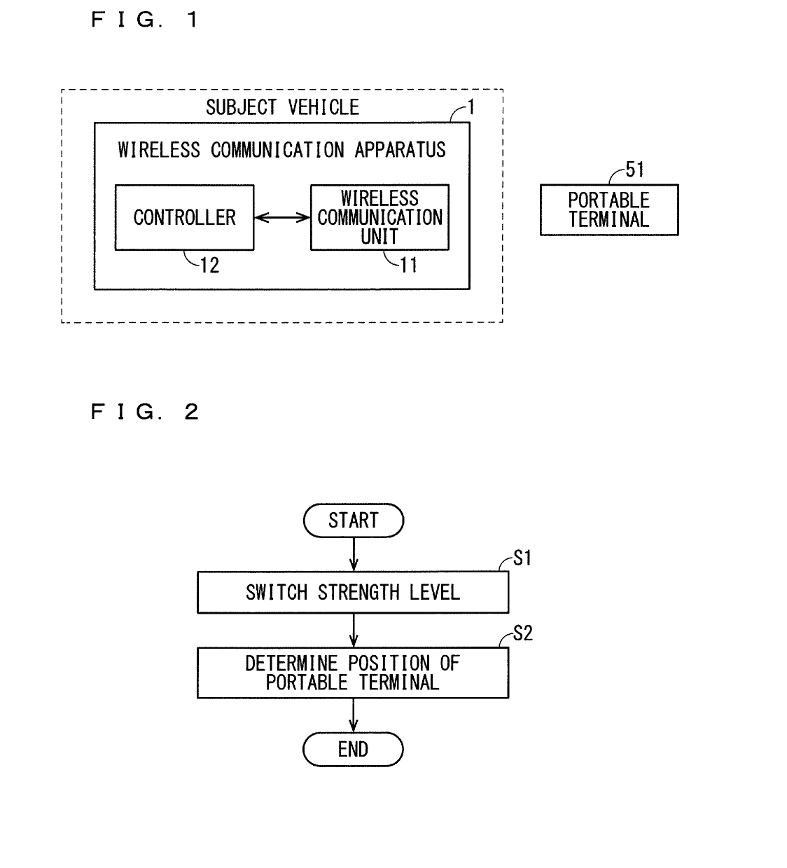

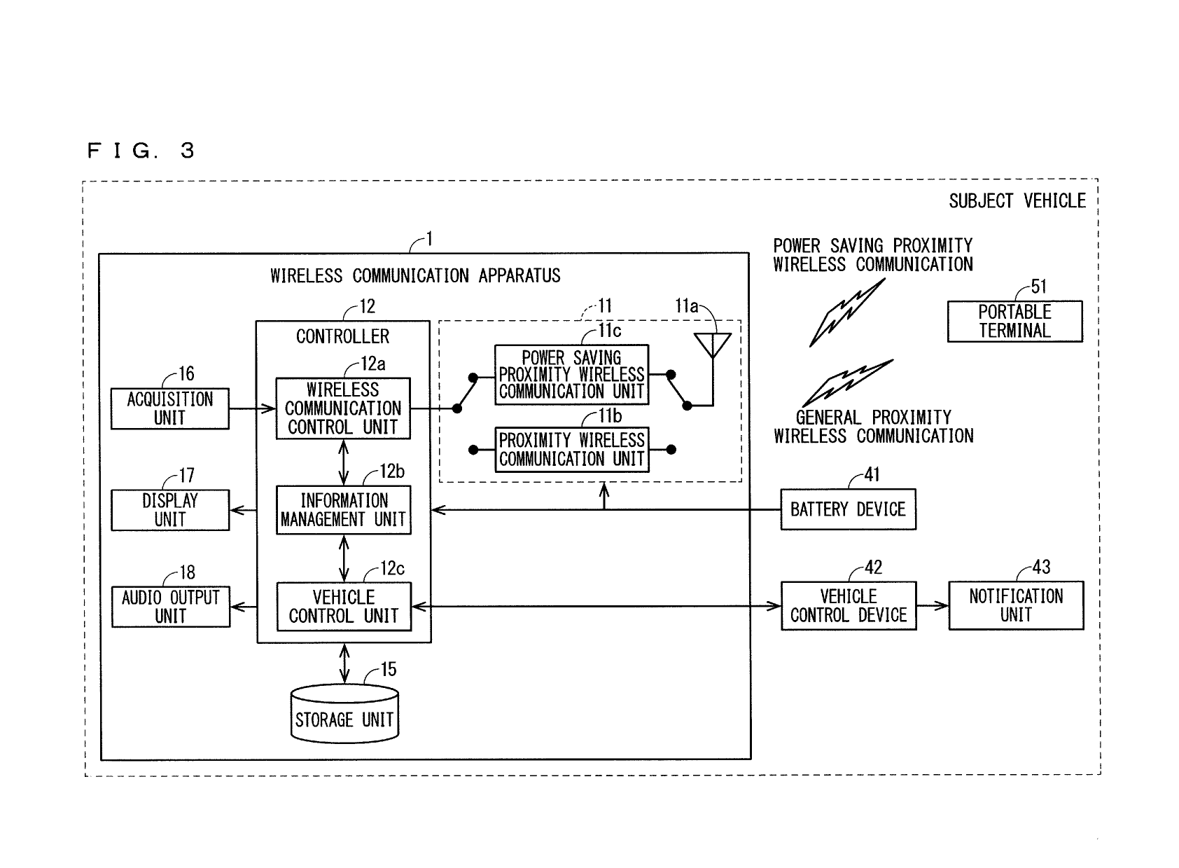

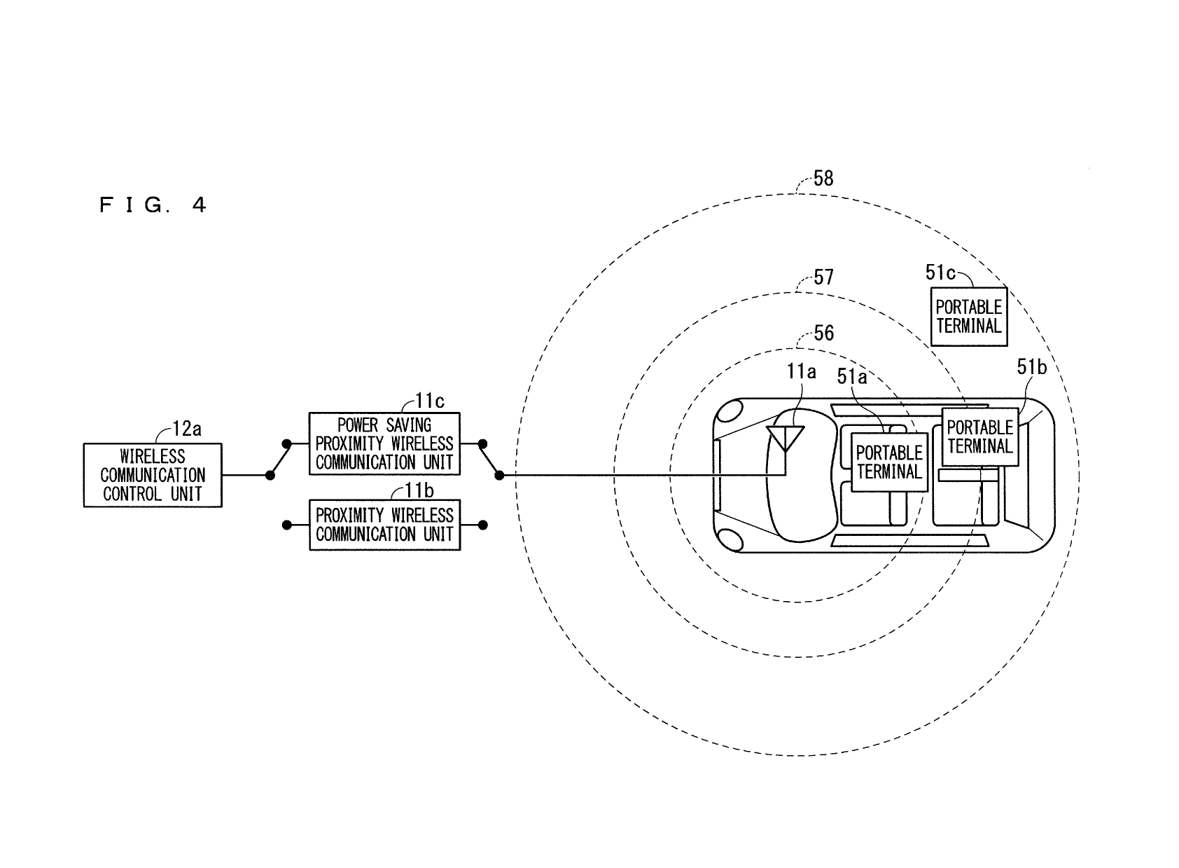

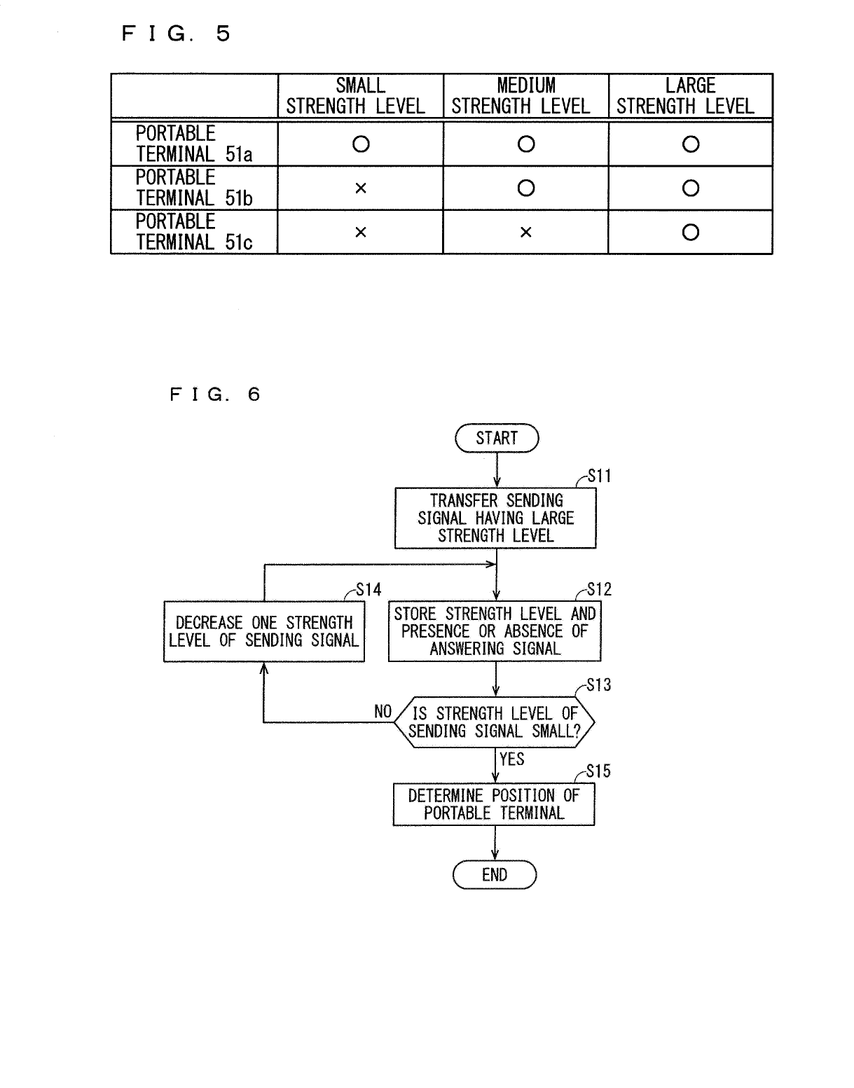

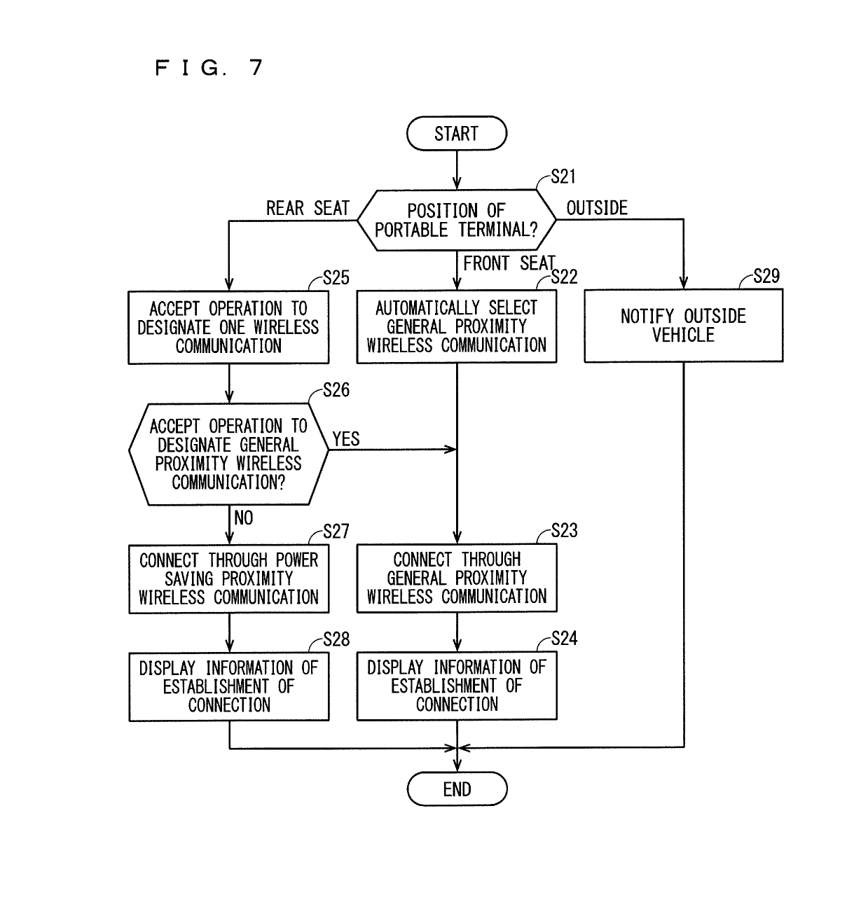

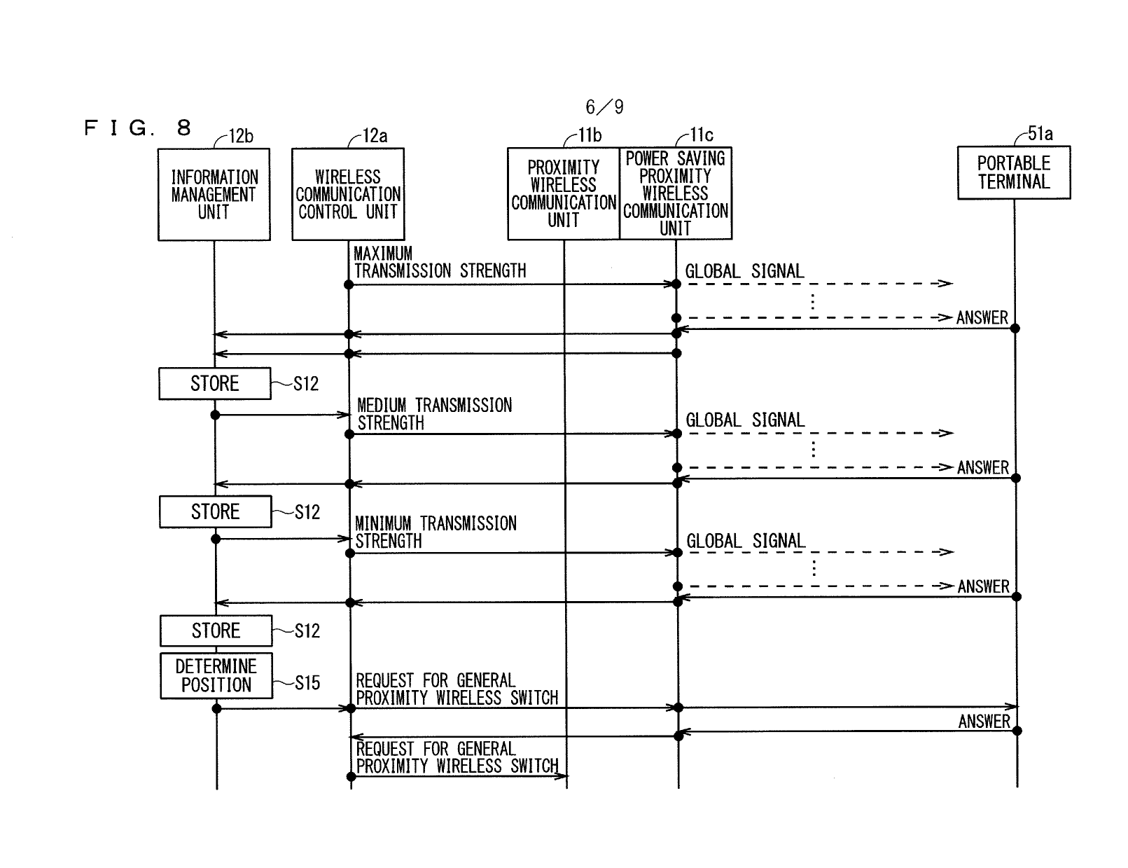

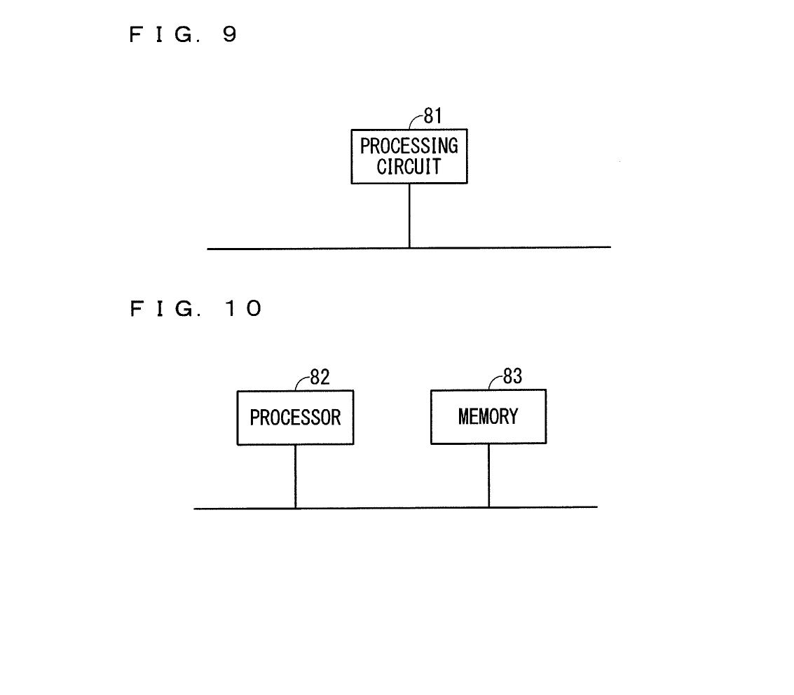

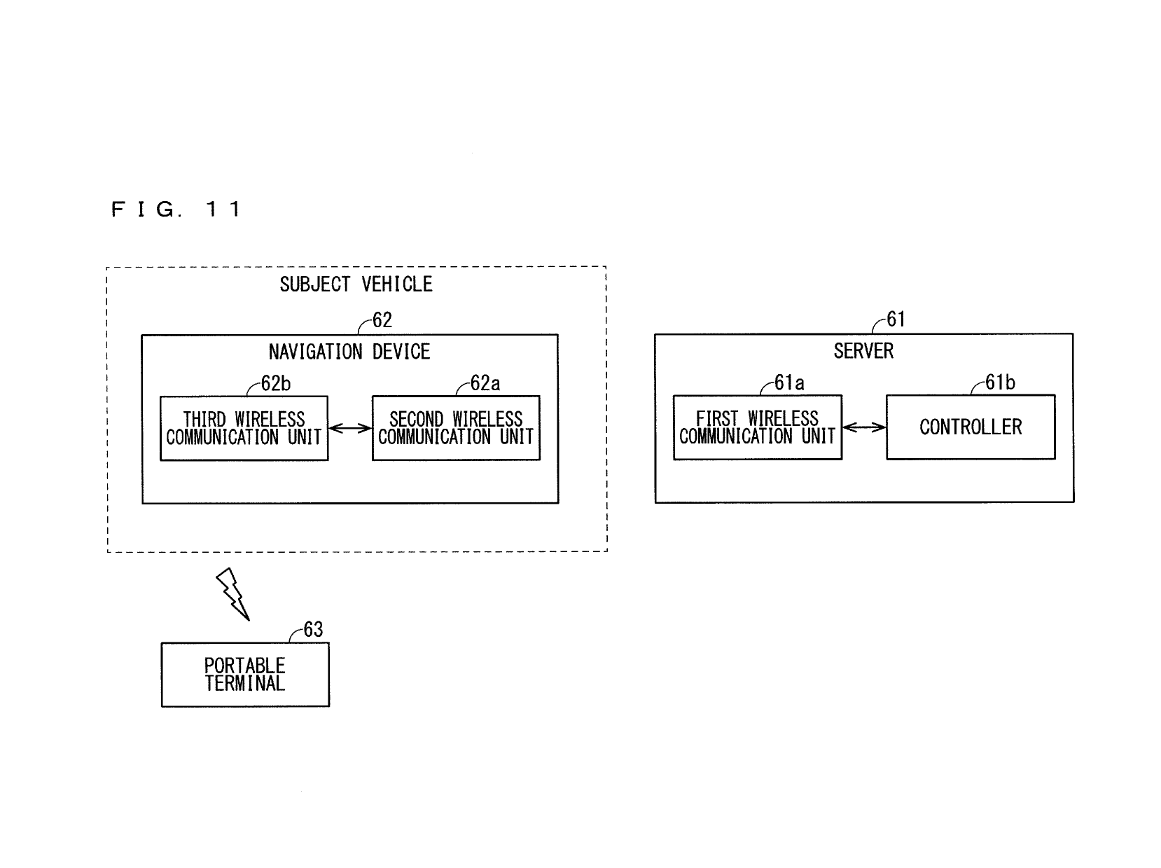

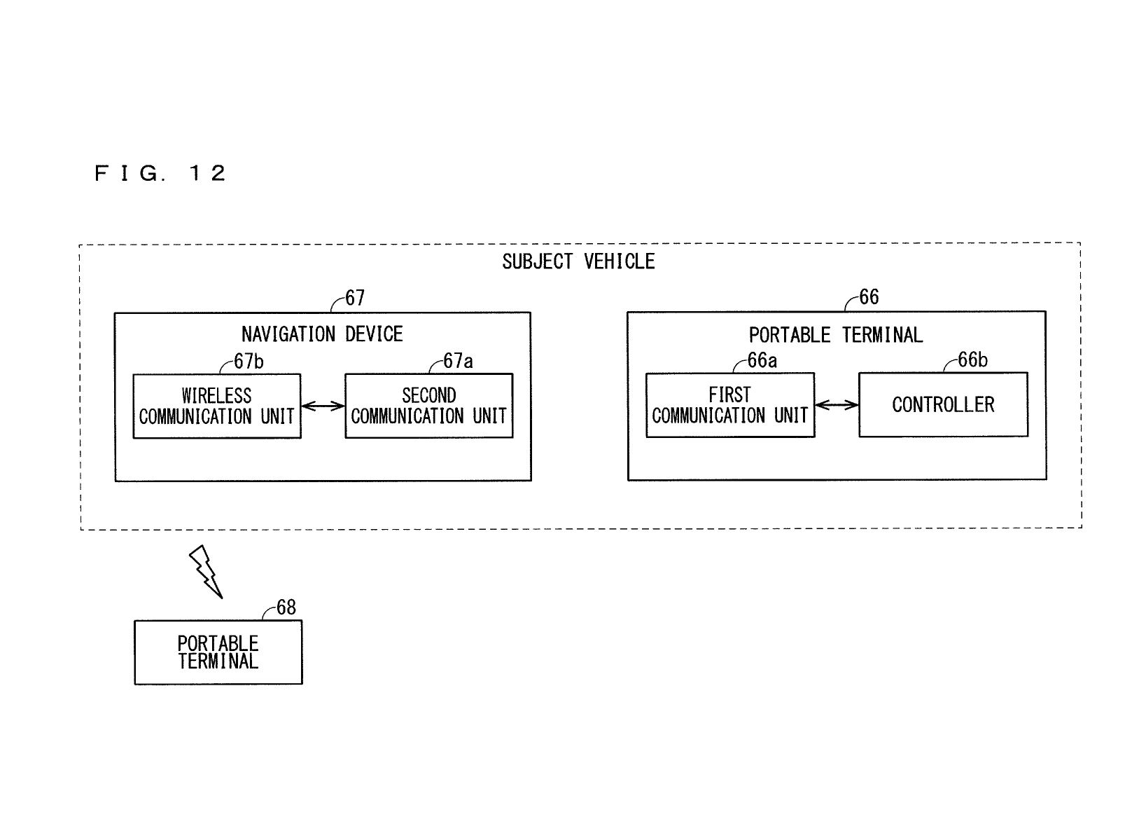

### BRIEF DESCRIPTION OF DRAWINGS

[FIG. 1] A block diagram illustrating a configuration of a wireless communication apparatus according to Embodiment 1.

[FIG. 2] A flowchart illustrating processing of the wireless communication apparatus according to Embodiment 1.

[FIG. 3] A block diagram illustrating a configuration of a wireless communication apparatus according to Embodiment 2.

[FIG. 4] A diagram illustrating processing of the wireless communication apparatus according to Embodiment 2.

[FIG. 5] A diagram illustrating the processing of the wireless communication apparatus according to Embodiment 2.

[FIG. 6] A flowchart illustrating the processing of the wireless communication apparatus according to Embodiment.

[FIG. 7] A flowchart illustrating the processing of the wireless communication apparatus according to Embodiment 2.

[FIG. 8] A timing chart illustrating an example of the processing of the wireless communication apparatus according to Embodiment 2.

[FIG. 9] A block diagram illustrating a hardware configuration of a wireless communication apparatus according to a modification.

[FIG. 10] A block diagram illustrating a hardware configuration of the wireless communication apparatus according to the modification.

[FIG. 11] A block diagram illustrating a configuration of a server according to the modification.

[FIG. 12] A block diagram illustrating a configuration of a portable terminal according to the modification.

### DESCRIPTION OF EMBODIMENTS

[Embodiment 1]

FIG. 1 is a block diagram illustrating a configuration of a wireless communication apparatus according to Embodiment 1. The wireless communication apparatus may be provided in a navigation device, and the configuration is not limited thereto.

The wireless communication apparatus 1 of FIG. 1 includes a wireless communication unit 11 and a controller 12 that integrally controls each components of the wireless communication apparatus 1. The wireless communication unit 11 is mounted on a vehicle and transfers a sending signal such as a global signal by radio by control of the controller 12. Hereinafter, a vehicle in which the wireless communication unit 11 is mounted and which is the object of attention is referred to as “subject vehicle”.

FIG. 2 is a flowchart illustrating processing of the wireless communication apparatus according to Embodiment 1.

In the step S1, the controller 12 switches, in stages, strength levels of the sending signal transferred by the wireless communication unit 11. When a portable terminal 51, which represents a communication terminal, receives the sending signal transferred from the wireless communication unit 11 by radio, the portable terminal 51 transfers an answering signal to the wireless communication unit 11 by radio. It should be noted that, as a portable terminal 51, a cellular phone, a smartphone, and so forth are applied.

When the processing of step S1 is executed, the portable terminal 51 which is located relatively far from the wireless communication unit 11 transfers the answering signal to the wireless communication unit 11 only when the strength levels of the sending signal is high. Meanwhile, the portable terminal 51 which is located relatively close to the wireless communication unit 11 transfers the answering signal to the wireless communication unit 11 regardless of the strength level of the sending signal being high or low.

Accordingly, in the step S2, the controller 12 determines the position of the portable terminal 51 based on the strength level of the sending signal and the presence or absence of the answering signal transferred from the portable terminal 51 that has received the sending signal to the wireless communication unit 11 by radio. As the positions of the portable terminal 51, a relative position of the portable terminal 51 with respect to the wireless communication unit 11, an absolute position of the portable terminal 51 that is calculable from the relative position, and so forth are assumed, for example. Thereafter, the processing of FIG. 2 ends.

[Summary of Embodiment 1]

In the wireless communication apparatus 1 according to Embodiment 1, the position of the portable terminal 51 is determined based on the strength level of the sending signal which is switched in stages, and the presence or absence of the answering signal transferred from the portable terminal 51 to the wireless communication unit 11 by radio. According to such a configuration, the position of a portable terminal is not determined by using the received signal strength that easily fluctuates by reflection of radio wave and boarding on the vehicle, therefore, various circuits for stabilizing the received signal strength are eliminated. Consequently, the simpler configuration is realized than that of the apparatus determining the position of the portable terminal using the received signal strength.

[Embodiment 2]

FIG. 3 is a block diagram illustrating a configuration of a wireless communication apparatus according to Embodiment 2. Hereinafter, of the components to be described in Embodiment 2, the components that are same or similar to those in Embodiment 1 are denoted by the same reference symbols and the description is made mainly on different components.

The wireless communication apparatus 1 of FIG. 3 is connected to a battery device 41 and a vehicle control device 42 mounted on a subject vehicle. Power stored in the battery device 41 is used as the power to operate a wireless communication unit 11 and a controller 12. The vehicle control device 42 is controlled by the controller 12 to control a notification unit 43 mounted on the subject vehicle.

Next, the configuration of the wireless communication apparatus 1 of FIG. 3 is described. The wireless communication apparatus 1 includes, in addition to the components of FIG. 1, a storage unit 15, an acquisition unit 16, a display unit 17 such as a liquid crystal display, and an audio output unit 18 such as a loudspeaker. And, in Embodiment 2, the wireless communication unit 11 includes an antenna 11a, a proximity wireless communication unit 11b, and a power saving proximity wireless communication unit 11c, and the controller 12 includes a wireless communication control unit 12a, an information management unit 12b, and a vehicle control unit 12c.

The wireless communication unit 11 is controlled by the wireless communication control unit 12a to connect the antenna 11a to, one of the proximity wireless communication unit 11b and the power saving proximity wireless communication unit 11c. When the antenna 11a is connected to the proximity wireless communication unit 11b, the wireless communication unit 11 communicates with the portable terminal 51 through general proximity wireless communication, and when the antenna 11a is connected to the power saving proximity wireless communication unit 11c, the wireless communication unit 11 communicates with the portable terminal 51 through power saving proximity wireless communication in which the power consumption is lower than the general proximity wireless communication. It should be noted that a first wireless communication according to the present invention can be referred to as general proximity wireless communication, and a second wireless communication according to the present invention can be referred to as power saving proximity wireless communication.

Basic rate (BR)/enhanced data rate (EDR) of Bluetooth, for example, may be applied to general proximity wireless communication, Bluetooth low energy (BLE) of Bluetooth, for example, may be applied to the power saving proximity wireless communication. Or, ZigBee (registered trademark), for example, may be applied to the power saving proximity wireless communication.

The wireless communication control unit 12a switches, in stages, strength level of a sending signal transferred by the wireless communication unit 11 by radio. At this point, the wireless communication control unit 12a controls to transfer the sending signal through the power saving proximity wireless communication. The portable terminal 51 that has received the sending signal transfers an answering signal to the wireless communication unit 11 through the power saving proximity wireless communication. And, the controller 12 stores the presence or absence of the answering signal transferred from the portable terminal 51 to the wireless communication control unit 12a, that is, the presence of absence of the answering signal received by the wireless communication control unit 12a into the storage unit 15.

FIG. 4 is a diagram illustrating an example of switching of the strength level of the sending signal. FIG. 5 is a diagram illustrating an example of results of the presence or absence of the answering signal stored in the storage unit 15, in the case of FIG. 4.

In FIG. 4, the antenna 11a is set on the front side rather than on the rear side of the inside of a subject vehicle, and the wireless communication unit 11 is transferring the sending signal while switching the strength level among three levels: small, medium, and large. A reachable range 56 of the sending signal of which, of the three levels, the strength level is small, extends to the front seat, but not to the rear seat. A reachable range 57 of the sending signal of which the strength level is medium extends to the rear seat of the subject vehicle as well as the front seat of the subject vehicle. A reachable range 58 of the sending signal of which the strength level is large extends outside the subject vehicle as well as inside of the subject vehicle. It should be noted that, although FIG. 4 is illustrated as if the reachable ranges 56, 57 extend outside the subject vehicle, a general vehicle in which inside thereof is generally closed by window panes and so forth is assumed to be as the subject vehicle, therefore, the reachable ranges 56, 57 do not extend outside the subject vehicle practically.

Next, the portable terminal 51a of FIG. 4 is located in the front seat of the subject vehicle. Therefore, as illustrated in FIG. 5, the result that the wireless communication unit 11 receives the answering signal from the portable terminal 51a is obtained, regardless of the strength level of the sending signal: small, medium, and large.

Next, the portable terminal 51b of FIG. 4 is located in the rear seat of the subject vehicle. Therefore, as illustrated in FIG. 5, the result that the wireless communication unit 11 does not receive the answering signal from the portable terminal 51b when the strength level of the sending signal is small, and the wireless communication unit 11 receives the answering signal from the portable terminal 51b when the strength level of the sending signal is medium or large, is obtained.

Next, the portable terminal 51c of FIG. 4 is located outside the subject vehicle. Therefore, as illustrated in FIG. 5, the result that the wireless communication unit 11 does not receive the answering signal from the portable terminal 51c when the strength level of the sending signal is small or medium, and the wireless communication unit 11 receives the answering signal from the portable terminal 51c when the strength level of the sending signal is large, is obtained.

The information management unit 12b of FIG. 3 determines the position of the portable terminal 51 based on the result of FIG. 5, that is, the strength level of the sending signal and the presence or absence of the answering signal. When the answering signal from the portable terminal 51 is received in response to any of the strength level of small, medium, and large, the information management unit 12b determines that the portable terminal 51 is located in the front seat of the subject vehicle. When the answering signal from the portable terminal 51 is received in response to only the strength level of medium and large, the information management unit 12b determines that the portable terminal 51 is located in the rear seat of the subject vehicle. When the answering signal from the portable terminal 51 is received in response to only the strength level of large, the information management unit 12b determines that the portable terminal 51 is located outside the subject vehicle.

The wireless communication control unit 12a connects the wireless communication unit 11 to the portable terminal 51 through one wireless communication selected between the general proximity wireless communication and the power saving proximity wireless communication based on the above determination result of the position of the portable terminal 51. When the connection is established, the controller 12 controls the display unit 17 to display information to the effect that the connection is established. However, it is not limited thereto, and in place of displaying, the controller 12 may control the audio output unit 18 to output audio information to the effect that the connection of established, or may control the both units.

In Embodiment 2, when the information management unit 12b determines that the portable terminal 51 is located in the front seat of the subject vehicle, the wireless communication control unit 12a automatically selects the general proximity wireless communication between the general proximity wireless communication and the power saving proximity wireless communication, and connects the wireless communication unit 11 to the portable terminal 51 through the general proximity wireless communication. Meanwhile, when the information management unit 12b determines that the portable terminal 51 is located in the rear seat of the subject vehicle, the wireless communication control unit 12a connects the wireless communication unit 11 to the portable terminal 51 through, between the general proximity wireless communication and the power saving proximity wireless communication. one of the general proximity wireless communication and the power saving proximity wireless communication designated in an operation for the acquisition unit 16.

It should be noted that a hard button, a touch panel, an audio input device and so forth are applied to the acquisition unit 16 which accepts the above described operation by a user.

When the information management unit 12b determines that the portable terminal 51 is located outside the subject vehicle, the vehicle control unit 12c controls the vehicle control device 42 and, moreover, the notification unit 43 to allow the notification unit 43 to notify outside the subject vehicle. In Embodiment 2, a headlamp of the subject vehicle is applied to the notification unit 43, and when the portable terminal 51 is determined to be located relatively close to the subject vehicle, the headlamp being the notification unit 43 notifies outside that the portable terminal 51 is detected by illumination.

It should be noted that, when only the portable terminal 51 registered in advance in the wireless communication apparatus 1, such as the portable terminal 51 of the user of the subject vehicle, is determined to be located outside the subject vehicle, the notification by the notification unit 43 may be executed. In this case, when the portable terminal 51 or the user approaches to the subject vehicle, the headlamp of the subject vehicle is illuminated. Consequently, the user readily finds the subject vehicle in a parking lot and so forth.

It should be noted that an audio output device such as a loudspeaker, not illustrated, for example, and the audio output unit 18 of the wireless communication apparatus 1 and so forth may be applied to the notification unit according to the present invention. And in the configuration thereof, when the portable terminal 51 is determined to be located relatively close to the subject vehicle, the vehicle control unit 12c may control the audio output unit 18 and so forth to output audio outside the subject vehicle.

FIGS. 6 and 7 are flowcharts illustrating processing of the wireless communication apparatus according to Embodiment 2.

First, in the step S11 of FIG. 6, the wireless communication control unit 12a controls the wireless communication unit 11 to transfer the sending signal of which the strength level is large, through the power saving proximity wireless communication. In response to this, the portable terminal 51 that has transferred the sending signal transfers the answering signal to the wireless communication unit 11.

In the step S12, the controller 12 stores the strength level of the sending signal and the presence or absence of the answering signal.

In the step S13, the wireless communication control unit 12a determines whether the strength level of the sending signal is small. When the strength level is determined to be small, the processing proceeds to the step S15. When the strength level is determined not to be small, that is, determined to be medium or large, the processing proceeds to the step S14.

In the step S14, the wireless communication control unit 12a decreases one strength level of the sending signal. Accordingly, for example, when the strength level is large immediately before proceeding to the step S14, the strength level is switched to medium in the step S14, and when the strength level is medium immediately before proceeding to the step S 14, the strength level is switched to small in the step S14. Thereafter, the processing returns to the step S11. Accordingly, the results of the presence or absence of the answering signal as illustrated in FIG. 5 are stored in the storage unit 15.

In the step S15, the information management unit 12b determines the position of the portable terminal 51 based on the result of the presence or absence of the answering signal stored in the storage unit 15, that is, the strength level of the sending signal and the presence or absence of the answering signal. Thereafter, the processing of FIG. 6 ends and the processing of FIG. 7 is performed.

The processing of FIG. 7 is performed on each of the portable terminals 51 determined the positions thereof. It should be noted that the processing of FIG. 7 may be performed only on the portable terminal 51 registered in advance in the wireless communication apparatus 1.

In the step S21, the wireless communication control unit 12a and the vehicle control unit 12c confirm determination results of the information management unit 12b. When the determination result indicates that the portable terminal 51 is located in the front seat of the subject vehicle, the processing proceeds to the step S22, when the determination result indicates that the portable terminal 51 is located in the rear seat of the subject vehicle, the processing proceeds to the step S25, and when the determination result indicates that the portable terminal 51 is located outside the vehicle, the processing proceeds to the step S29.

When the processing proceeds from the step S21 to the step S22, the wireless communication control unit 12a automatically selects the general proximity wireless communication between the general proximity wireless communication and the power saving proximity wireless communication, as the wireless communication to be connected.

In the step S23, the wireless communication control unit 12a connects the wireless communication unit 11 to the portable terminal 51 through the general proximity wireless communication.

In the step S24, when the connection is established, the controller 12 controls the display unit 17 to display information to the effect that the connection is established. Thereafter, the processing of FIG. 7 ends.

When the processing proceeds from the step S21 to the step S25, the acquisition unit 16 accepts an operation to designate one wireless communication between the general proximity wireless communication and the power saving proximity wireless communication. At this point, the controller 12 may control the display unit 17 to display information to the effect that the operation is encouraged to be performed by the acquisition unit 16, and may also control the audio output unit 18 to output audio information to this effect.

In the step S26, the wireless communication control unit 12a determines whether the acquisition unit 16 accepts the operation to designate the general proximity wireless communication. When the determination that the operation to designate the general proximity wireless communication is accepted is made, the processing proceeds to the step S23, and when the determination that the operation to designate not the general proximity wireless communication but the power saving proximity wireless communication is accepted is made, the processing proceeds to the step S27.

In the step S27, the wireless communication control unit 12a connects the wireless communication unit 11 to the portable terminal 51 through the power saving proximity wireless communication.

In the step S28, when the connection is established, the controller 12 controls the display unit 17 to display information to the effect that the connection is established. Thereafter, the processing of FIG. 7 ends.

When the processing proceeds from the step S21 to the step S29, the vehicle control unit 12c controls the notification unit 43 mounted on the subject vehicle to notify outside the vehicle Thereafter, the processing of FIG. 7 ends.

FIG. 8 is a timing chart illustrating an example of the processing of FIGS. 6 and 7. Here, description is made of the case where only the portable terminal 51a of FIG. 4 exists. It should be noted that the reference symbols of steps in FIG. 8 correspond to the reference symbols of steps in FIGS. 6 and 7.

The wireless communication control unit 12a controls the power saving proximity wireless communication unit 11c to transfer the sending signal of which the strength level is large, through the power saving proximity wireless communication. In response to this, the portable terminal 51a located in the front seat of the subject vehicle transfers the answering signal to the power saving proximity wireless communication unit 11c. It should be noted that, as illustrated in FIG. 8, the sending signal is transferred multiple times.

In the step S12 of the first time, the reception of the answering signal from the portable terminal 51a is stored in the storage unit 15.

Thereafter, the wireless communication control unit 12a controls the power saving proximity wireless communication unit 11c to transfer the sending signal of which the strength level is medium, through the power saving proximity wireless communication. In response to this, the portable terminal 51a located in the front seat of the subject vehicle transfers the answering signal to the power saving proximity wireless communication unit 11c. Here, the sending signal is also transferred multiple times.

In the step S12 of the second time, the reception of the answering signal from the portable terminal 51a is stored in the storage unit 15.

Thereafter, the wireless communication control unit 12a controls the power saving proximity wireless communication unit 11c to transfer the sending signal of which the strength level is small, through the power saving proximity wireless communication. In response to this, the portable terminal 51a located in the front seat of the subject vehicle transfers the answering signal to the power saving proximity wireless communication unit 11c. Here, the sending signal is also transferred multiple times.

In the step S12 of the third time, the reception of the answering signal from the portable terminal 51a is stored in the storage unit 15.

In the step S15, the information management unit 12b determines that the portable terminal 51a is located in the front seat of the subject vehicle based on the strength level of the sending signal and the presence or absence of the answering signal.

Thereafter, the wireless communication control unit 12a connects the wireless communication unit 11 to the portable terminal 51a determined to be located in the front seat of the vehicle, through the general proximity wireless communication. Here, as illustrated in FIG. 8, the information management unit 12b requests to the portable terminal 51a for a general proximity wireless switch through the wireless communication control unit 12a and the power saving proximity wireless communication unit 11c. And, when the wireless communication control unit 12a receives the answering signal from the portable terminal 51a in response to the request through the power saving proximity wireless communication unit 11c, the wireless communication control unit 12a requests to the proximity wireless communication unit 11b for a general proximity wireless switch.

Accordingly, the wireless communication unit 11 and the portable terminal 51 are connected each other through the general proximity wireless communication.

[Summary of Embodiment 2]

In the wireless communication apparatus 1 according to Embodiment 2, the portable terminal 51 is determined to be located in any of the front seat, the rear seat, and outside the subject vehicle. Accordingly, communication control and notification control suitable to the position of the portable terminal 51 in the subject vehicle are operated. It should be noted that, the determination results by the information management unit 12b are not limited to the front seat, rear seat, and outside of the subject vehicle. For example, when the antenna 11a of the wireless communication unit is set on the driver's seat side rather than on the passenger seat side, thereby, instead of determining the position of the portable terminal 51 is the front seat of the subject vehicle, the position of the portable terminal 51 is determined to be the driver's seat of the subject vehicle or determined to be passenger seat of the subject vehicle.

Meanwhile, BR/EDR of Bluetooth is not compatible with BLE due to the difference in protocol, therefore, many service functions available to BR/EDR are not available to BLE. Accordingly, the configuration, in which BR/EDR and BLE are applied to the general proximity wireless communication and the power saving proximity wireless communication, respectively, causes a trouble to the driver to switch the wireless communication to BR/EDR while driving, even if the driver wishes to use many service functions prepared for BR/EDR.

Whereas, according to Embodiment 2, when the portable terminal 51 is determined to be located in the front seat of the subject vehicle, the wireless communication unit 11 and the portable terminal 51 are automatically connected through the general proximity wireless communication. Accordingly, the driver can use many service functions without the connection operation.

Whereas, according to Embodiment 2, when the portable terminal 51 is determined to be located in the rear seat of the subject vehicle, the wireless communication unit 11 and the portable terminal 51 are connected through the wireless communication designated by the acquisition unit 16. Accordingly, a user in the rear seat, who is not required to focus on driving and can afford to operate the acquisition unit 16, can use many service functions by operating the acquisition unit 16 appropriately.

Also, according to Embodiment 2, when the portable terminal 51 is determined to be located outside the subject vehicle, the notification unit 43 notifies outside the subject vehicle. Consequently, the user readily finds the subject vehicle in a parking lot and so forth.

[Modification]

The controller 12 in the above described wireless communication apparatus 1 is realized with a processing circuit 81 illustrated in FIG. 9. Specifically, the processing circuit 81 includes the controller 12 that switches, in stages, the strength level of the sending signal transferred by the wireless communication unit 11 by radio, and determines the position of the portable terminal 51 based on the strength level and the presence or absence of the answering signal transferred from the portable terminal 51 that has received the sending signal to the wireless communication unit 11 by radio. A dedicated hardware may be applied to the processing circuit 81, and a processor executing a program stored in a memory may also be applied to the processing circuit 81. A central processing unit, a processing device, an arithmetic device, a microprocessor, microcomputer, a Digital Signal Processor and so forth correspond to the processor.

When a dedicated hardware is applied to the processing circuit 81, a single circuit, a composite circuit, a programmed processor, a parallel programed processor. an Application Specific Integrated Circuit (ASIC), a Field Programmable Gate Array (FPGA), and combinations thereof correspond to the processing circuit 81. Each of functions of respective parts of the controller 12 may be realized by a circuit dispersed from the processing circuit, and may also be realized by one processing circuit with each of the functions of the respective parts are integrated.

When a processor is applied to the processing circuit 81, the function of the controller 12 is realized by a combination with a software and so forth. It should be noted that a software, a firmware, and, a software and a firmware, for example, correspond to the software and so forth. The software and so forth are written as programs and stored in a memory. As illustrated in FIG. 10, a processor 82 that is applied to the processing circuit 81, reads and runs the programs stored in a memory 83, thereby each of the functions is realized. Specifically, the wireless communication apparatus 1 includes the memory 83 for storing the program to consequently execute, by the processing circuit 81, the step in which the strength level of the sending signal transferred by the wireless communication unit 11 by radio is switched, in stages, and the position of the portable terminal 51 is determined based on the strength level and the presence or absence of the answering signal transferred from the portable terminal 51 that has received the sending signal to the wireless communication unit 11 by radio. In other words, the program causes a computer to execute procedures and methods of the controller 12. Here, a nonvolatile or volatile semiconductor memory such as Random Access Memory (RAM), Read Only Memory (ROM), flash memory, Erasable Programmable Read Only Memory (EPROM), Electrically Erasable Programmable Read Only Memory (EEPROM), and a Hard Disk Drive (HDD), a magnetic disk, a flexible disk, an optical disk, a compact disk, a minidisk, Digital Versatile Disc (DVD), and a drive device thereof and so forth correspond to the memory 83.

The configuration in which each functions of the controller 12 are realized by one of a hardware and a software and so forth is described so far. However, the configuration is not limited thereto, and the configuration in which parts of the controller 12 are realized by the dedicated hardware, while other parts are realized by the software and so forth, may be allowed. It should be noted that, the description made above is also applied to the acquisition unit 16.

As described above, the processing circuit 81 is capable of realizing each functions described above by a hardware, a software and so forth, and a combination thereof.

Also, the above-described wireless communication apparatus 1 is also applicable to a wireless communication system constructed as a system by appropriately combining a navigation device such as Portable Navigation Device, a communication terminal, functions of an application to be installed therein. and a server. In this case, each functions or each components of the wireless communication apparatus 1 described above, may be distributed to each devices constructing the system, or may be arranged in any one of the devices in an integrated manner.

FIG. 11 is a block diagram illustrating a configuration of a server 61 according to Modification. The server 61 of FIG. 11 includes a first wireless communication unit 61a and a controller 61b, and a navigation device 62 mounted on a subject vehicle includes a second wireless communication unit 62a that communicates with the first wireless communication unit 61a by radio, and a third wireless communication unit 62b that corresponds to the wireless communication unit 11 of FIG. 1.

The controller 61b of the server 61 controls the third wireless communication unit 62b of the navigation device 62 via the first wireless communication unit 61a and the second wireless communication unit 62a, thereby switches, in stages, the strength level of the sending signal transferred by the third wireless communication unit 62b by radio. And, the presence or absence of the answering signal transferred from the portable terminal 63 to the third wireless communication unit 62b by radio, is transferred to the controller 61b via the first wireless communication unit 61a and the second wireless communication unit 62a. The controller 61b determines the position of the portable terminal 63 based on the strength level and the presence or absence of the answering signal. Such a configuration also obtains the similar effects to Embodiment 1.

FIG. 12 is a block diagram illustrating a configuration of a portable terminal 66 according to Modification. The portable terminal 66 of FIG. 12 includes a first communication unit 66a and a controller 66b, the navigation device 67 mounted on the subject vehicle includes a second communication unit 67a that communicates with the first communication unit 66a by radio or wire, and a wireless communication unit 67b that corresponds to the wireless communication unit 11 of FIG. 1

The controller 66b of the portable terminal 66 controls the wireless communication unit 67b of the navigation device 67 via the first communication unit 66a and the second communication unit 67a, thereby switches, in stages, the strength level of the sending signal transferred by the wireless communication unit 67b by radio. And, the presence or absence of the answering signal transferred from the other portable terminal 68 to the wireless communication unit 67b by radio, is transferred to the controller 66b via the first wireless communication unit 66a and the second wireless communication unit 67a. The controller 66b determines the position of the other portable terminal 68 based on the strength level and the presence or absence of the answering signal. Such a configuration also obtains the similar effects to Embodiment 1. It should be noted that, in this description, the wireless communication unit that transfers the sending signal, in stages, is provided in the navigation device 67, the configuration is not limited thereto, and, for example, the portable terminal 66 may be provided therewith.

It should be noted that Embodiments and Modification of the present invention can be arbitrarily combined and can be appropriately modified or omitted without departing from the scope of the invention.

While the invention has been described in detail, the forgoing description is in all aspects illustrative and not restrictive. It is understood that numerous other modifications and variations can be devised departing from the scope of the invention.

### EXPLANATION OF REFERENCE SIGNS

1 wireless communication apparatus, 11 wireless communication unit, 12 controller, 16 acquisition unit, 43 notification unit, 51 portable terminal

1. A wireless communication apparatus, comprising:
a wireless communication unit mounted on a vehicle; and
a controller configured to switch, in stages, a strength level of a sending signal transferred by the wireless communication unit by radio, and, based on the strength level and presence or absence of an answering signal transferred from a communication terminal that has received the sending signal to the wireless communication unit by radio, determine a position of the communication terminal.

2. The wireless communication apparatus according to claim 1,
wherein the wireless communication unit is configured to communicate with the communication terminal with a first wireless communication and a second wireless communication in which power consumption is lower than the first wireless communication, and
wherein the controller is configured to
control the wireless communication unit to transfer the sending signal through the second wireless communication, and
connect the wireless communication unit to the communication terminal through one wireless communication selected between the first wireless communication and the second wireless communication based on a determination result of the position of the communication terminal,

3. The wireless communication apparatus according to claim 2, wherein the controller is configured to, based on the strength level and the presence or absence of the answering signal, determine that the communication terminal is located in a front seat, in a rear seat, or outside the vehicle.

4. The wireless communication apparatus according to claim 3, wherein, when a determination that the communication terminal is located in the front seat of the vehicle is made, the first wireless communication is automatically selected as the one wireless communication.

5. The wireless communication apparatus according to claim 3, wherein, when a determination that the communication terminal is located in the rear seat of the vehicle is made, one of the first wireless communication and the second wireless communication designated in an operation for an acquisition unit is selected as the one wireless communication.

6. The wireless communication apparatus according to claim 3, wherein, when a determination that the communication terminal is located outside the vehicle, the controller is configured to control a notification unit mounted on the vehicle to notify outside the vehicle.

7. A wireless communication method, comprising: switching, in stages, a strength level of a sending signal transferred by the wireless communication unit by radio; and, determining a position of a communication terminal based on the strength level and presence or absence of an answering signal transferred from the communication terminal that has received the sending signal to the wireless communication unit by radio.
